(19) United States
(12) Patent Application Publication
(10) Pub. No.: US 2013/0157078 A1
(43) Pub. Date: Jun. 20, 2013

(54) Nickel-Cobalt-Based Alloy And Bond Coat And Bond Coated Articles Incorporating The Same

(71) Applicants: Kivilcim Onal, Greer, SC (US); Canan Uslu Hardwicke, Simpsonville, SC (US); Jon Conrad Schaeffer, Greenville, SC (US)

(72) Inventors: Kivilcim Onal, Greer, SC (US); Canan Uslu Hardwicke, Simpsonville, SC (US); Jon Conrad Schaeffer, Greenville, SC (US)

(73) Assignee: GENERAL ELECTRIC COMPANY, Schenectady, NY (US)

(21) Appl. No.: 13/330,090

(22) Filed: Dec. 19, 2011

(51) Int. Cl. B32B 15/01; B32B 15/18; C22C 19/05; B32B 15/20

(52) U.S. Cl. 428/650; 428/457; 428/678; 420/443; 420/591

(57) ABSTRACT

In an exemplary embodiment, a high temperature oxidation and hot corrosion resistant MCrAlX alloy is disclosed, wherein, by weight of the alloy, M comprises nickel in an amount of at least about 30 percent and X comprises from about 0.005 percent to about 0.19 percent yttrium. In another exemplary embodiment, a coated article is disclosed. The article includes a substrate having a surface. The article also includes a bond coat disposed on the surface, the bond coat comprising a high temperature oxidation and hot corrosion resistant MCrAlX alloy, wherein, by weight of the alloy, M comprises at least about 30 percent nickel and X comprises about 0.005 percent to about 0.19 percent yttrium.

### BACKGROUND OF THE INVENTION

The subject matter disclosed herein relates to metallic alloy compositions suitable for use in high temperature environments, and more particularly to metallic alloy compositions suitable for use as articles or bond coat materials in high temperature environments to provide protection from oxidation and hot corrosion.

In harsh environments such as a turbine engine, metallic overlay coatings and diffusion coatings act as bond coatings (i.e. MCrAlY and/or aluminides) for thermal barrier coatings (TBCs). The coatings protect the underlying metal alloy substrate against heat and the corrosive and oxidizing environment of the hot gases. The TBC provides a heat reducing barrier between the hot combustion gases and the metal alloy substrate, and can prevent, mitigate, or reduce potential heat, corrosion, and/or oxidation induced damage to the substrate.

MCrAlY alloys are a family of high temperature coatings, wherein M is selected from one or a combination of iron, nickel and cobalt; Cr is chromium; Al is aluminum; and Y is yttrium. Sometimes other rare earth elements are substituted for Y such as lanthanum (La) or scandium (Sc). These MCrAlY coatings usually have gamma and beta phases in the alloy microstructures. Various alloying elements, such as Si, Hf, Pd and Pt, have been added to gamma/beta MCrAlY alloys to improve oxidation and/or hot corrosion resistance, but this can lead to reduction in strain tolerance of the bond coat materials and may result in a reduction of spallation life of the coating systems in which they have been employed, particularly those which include TBCs.

There is another class of overlay MCrAlY coatings which are based on gamma and gamma prime phase alloy microstructures. An advantage of gamma and gamma prime MCrAlY coatings is that they have a smaller thermal expansion mismatch with superalloys of the underlying turbine articles and the gamma prime strengthens the materials resulting in a relatively high resistance to thermal fatigue. A high thermal fatigue resistance in these bond coatings is very desirable, since thermal fatigue is a principal mode of degradation of turbine blades operated at elevated temperatures. While these coatings are desirable, they generally have operating lifetimes that are determined by their ability to maintain, or avoid the depletion of, elements such as aluminum and chromium that are essential to maintaining protective oxides and prevent spallation of TBC coatings and protective coating systems that incorporate them.

Therefore, a need exists to provide bond coat materials that improve the spallation resistance of protective coating systems in which they are employed, particularly those which employ TBCs.

### BRIEF DESCRIPTION OF THE INVENTION

According to one aspect, in an exemplary embodiment, a high temperature oxidation and hot corrosion resistant MCrAlX alloy is disclosed. The alloy includes, by weight of the alloy, M comprising nickel in an amount of at least about 30 percent and X comprising from about 0.005 percent to about 0.19 percent yttrium.

According to another exemplary embodiment, a coated article is disclosed. The article includes a substrate having a surface. The article also includes a bond coat disposed on the surface, the bond coat comprising a high temperature oxidation and hot corrosion resistant MCrAlX alloy, wherein, by weight of the alloy, M comprises at least about 30 percent nickel and X comprises about 0.005 percent to about 0.19 percent yttrium.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic sectional view of exemplary embodiments of articles as disclosed herein;

FIG. 2 is a sectional view of a surface region of an exemplary embodiment of a substrate in the form of a turbine blade and bond coating as disclosed herein;

FIG. 3 is a second exemplary embodiment of a substrate in the form of a turbine blade and bond coating as disclosed herein;

FIG. 4 is a third exemplary embodiment of a substrate in the form of a turbine blade and bond coating as disclosed herein;

FIG. 5 is a fourth exemplary embodiment of a substrate in the form of a turbine blade and bond coating as disclosed herein;

FIG. 6 is a fifth exemplary embodiment of a substrate in the form of a turbine blade and bond coating as disclosed herein;

FIG. 7 is a sixth exemplary embodiment of a substrate in the form of a turbine blade and bond coating as disclosed herein;

FIG. 8 is a plot of furnace cyclic testing (FCT) life measured in cyclic hours to spallation at 2000° F./20 hour dwell time for an exemplary embodiment of a bond coat alloy as disclosed herein as well as two comparative bond coat alloys;

FIG. 9 is a plot of FCT life measured in cyclic hours to spallation at 2000° F./45 minute dwell time for an exemplary embodiment of a bond coat alloy as disclosed herein as well as two comparative bond coat alloys; and

FIG. 10 is a plot of the strain tolerance measured as percentage of strain at crack initiation for an exemplary embodiment of a bond coat alloy as disclosed herein as well as two comparative bond coat alloys.

The detailed description explains embodiments of the invention, together with advantages and features, by way of example with reference to the drawings.

### DETAILED DESCRIPTION OF THE INVENTION

Referring to the Figures, a gamma-gamma prime MCrAlX alloy 100 is disclosed that is suitable for use as a bond coat 110 material and provides more than 50° F. improvement in the operating temperature capability over existing comparative gamma-beta bond coat materials, as described herein. More particularly, the MCrAlX alloy 100 comprises a NiCoCrAlY alloy 100. This material may be used as a metallic overlay bond coating that protects an underlying metallic superalloy substrate from degradation by oxidation and hot corrosion. The composition of the NiCoCrAlY alloy 100 bond coat 110 material is similar to certain Ni-based superalloy substrate compositions. Without being limited by theory, the similarity of the composition of the NiCoCrAlY alloy 100 bond coat 110 material and superalloy substrate compositions reduces the composition gradient of certain of the coating or substrate alloy constituents, thereby also reducing the potential for diffusion processes that might tend to deplete the coating or substrate of certain essential constituents, such as, for example, aluminum and chromium, that provide surface oxides associated with oxidation and hot corrosion protection, or enrichment in constituents that do not promote oxidation or hot corrosion protection, particularly by reducing interdiffusion at the substrate/coating interface. With reduced chemical constituent gradients, the bond coating/substrate alloys can sustain their original compositions for prolonged times; depletion of essential elements such as Al, Cr in the bond coat 110 material, as well as enrichment with elements that were not in the original bond coat, becomes more gradual. For example, the bond coat 110 material can sustain a thin, continuous, protective alumina scale for longer intervals at high operating temperatures, which in turn promotes improved spallation lifetimes of thermal barrier coatings (TBC) proximate the bond coat 110 material, as described herein. The NiCoCrAlY alloys 100 are substantially Si-free, thereby preventing the potential formation of brittle TiₓSi_{y} intermetallic phases, which can reduce the spallation lifetimes of TBC coatings disposed on bond coat materials that include silicon, particularly when the substrate alloy includes titanium, such as GTD111, which has a nominal composition, in weight percent of the alloy, of 14% chromium, 9.5% cobalt, 3.8% tungsten, 1.5% molybdenum, 4.9% titanium, 3.0% aluminum, 0.1% carbon, 0.01% boron, 2.8% tantalum, and the balance nickel and incidental impurities, or Rene N4, which has a nominal composition, in weight percent of the alloy, of 7.5% cobalt, 9.75% chromium, 4.20% aluminum, 3.5% titanium, 1.5% molybdenum, 4.8% tantalum, 6.0% tungsten, 0.5% columbium (niobium), 0.05% carbon, 0.15% hafnium, 0.004% boron, and the balance nickel and incidental impurities. In certain embodiments, the NiCoCrAlY alloys 100 described herein may include up to 1.25% germanium, particularly the high temperature ductility. The NiCoCrAlY alloys 100 described herein may be used in various turbine engine applications to enable higher engine operating temperatures, improved operating efficiencies and/or longer inspection intervals.

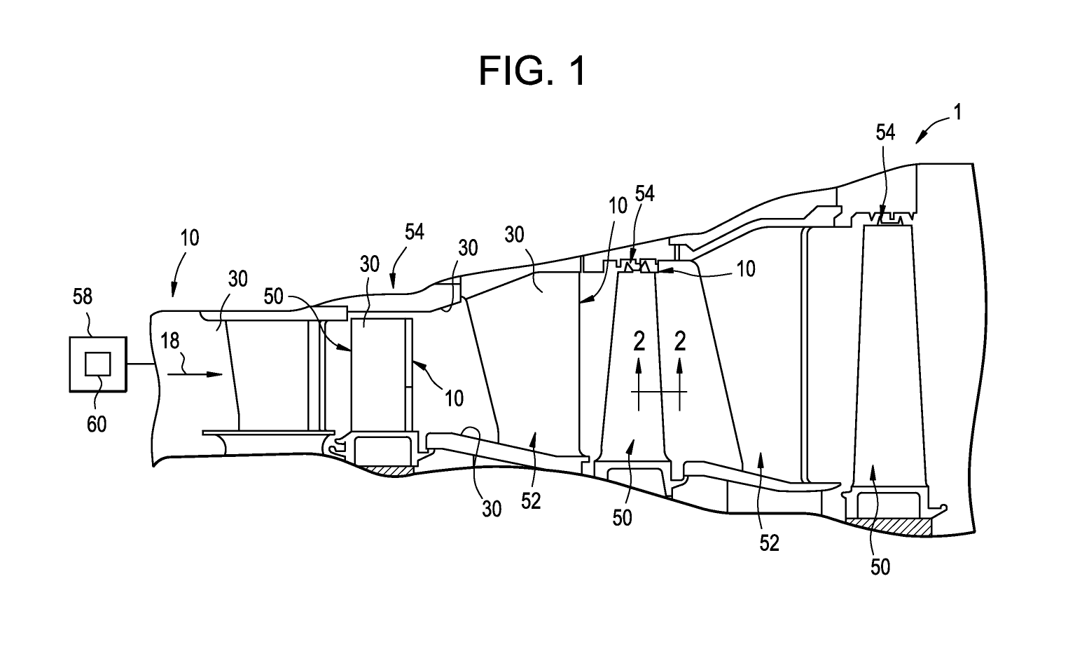

Referring to FIGS. 1-10, a high temperature oxidation and hot corrosion resistant MCrAlX alloy 100 is disclosed herein. The MCrAlX alloy 100 may be used for any desired application, but is particularly suited for use as a bond coat 110 material for various high temperature articles, particularly various components 10 of a turbine engine 1, and even more particularly for use as a bond coat 110 material for various components 10 of an industrial gas turbine that comprise the hot gas flow path 18 and surfaces 30 that are exposed to the high temperature combustion gases that flow through this path. These bond coat 110 materials are particularly well-suited for use with various turbine blades (or turbine buckets) 50, but are also well suited for use with other components, including vanes (or turbine nozzles) 52, shrouds 54, combustors 58, fuel nozzles 60 and the like, and including subcomponents and subassemblies of these components. The MCrAlX alloy 100 may be applied as an overlay bond coat 110 or bond coating in any of the applications mentioned to any suitable substrate 120, particularly various superalloy substrates 120, including Co-based, Ni-based or Fe-based superalloy substrates, or combinations thereof. In an exemplary embodiment, the MCrAlX alloys 100 disclosed herein may be used, for example, as a bond coat 110 on the pressure or suction surface of the airfoil section or blade tip of a gas turbine blade 50 as illustrated in FIG. 1.

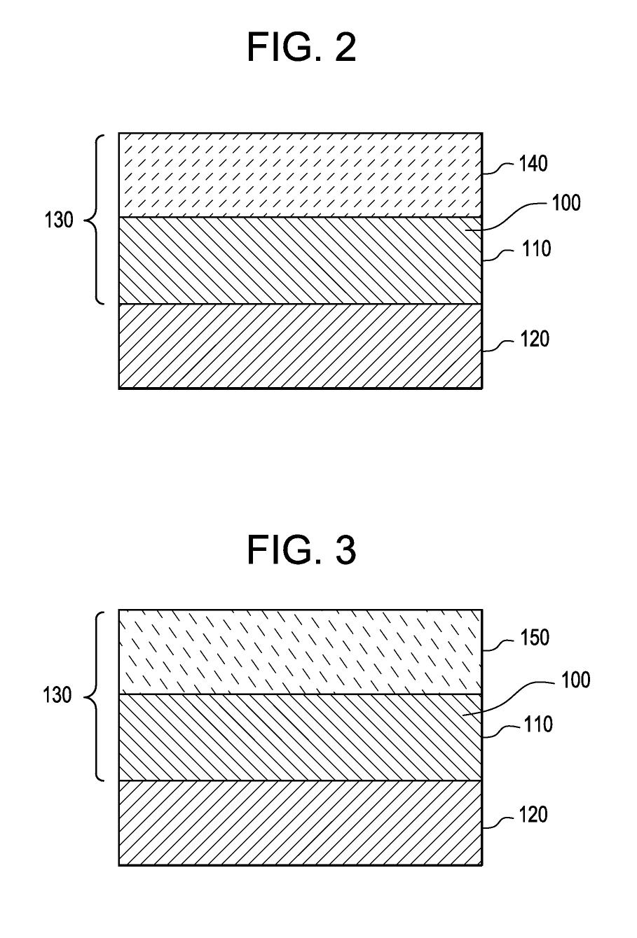

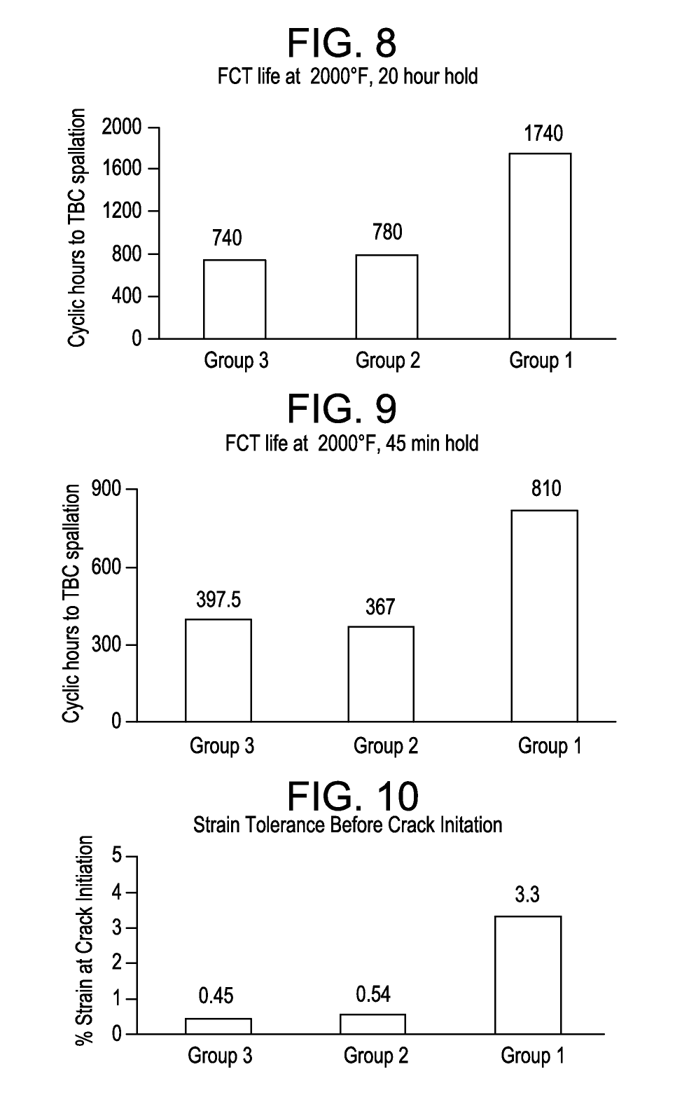

In an exemplary embodiment, a surface 30 of a component 10, such as a turbine blade 50, is protected by the bond coat 110 material as a metallic protective coating layer, as illustrated in greater detail in FIG. 2, which depicts an enlargement of a section through the surface 30 of a component 10, such as a turbine blade 50. The surface 30 may include any portion of the component 10 on which it is desirable to provide a bond coat 110 material to protect the substrate 120 from oxidation or hot corrosion, or both of them, including surfaces 30 that comprise that hot gas flow path 18 and are directly exposed to the hot combustion gases that flow through this path, as well as other surfaces, including those that are not directly exposed to the hot combustion gases, but which may be exposed to high temperatures resulting from these gases. In one exemplary embodiment, the surface 30 may include the surface of the airfoil section or blade tip of a turbine blade 50. Bond coat 110 may be used by itself to protect the surface 30 as shown in FIG. 8, or may be used in conjunction with other high temperature materials, including other high temperature coating materials, to provide a protective system 130 of coating layers as described herein, wherein the bond coat 110 may be used, for example, as an under layer or an inner layer or an outer layer, or a combination thereof, in such a system. The bond coat 110 may be incorporated as described above into various high temperature articles, particularly various components 10 of a turbine engine 1, and may be incorporated into newly formed articles that have not yet been utilized in the applications for which they are intended, but may also be incorporated into articles that have been utilized in service as a replacement bond coat or a repair bond coat, or a combination thereof, for such articles.

Protective system 130 may include bond coat 110 as an under layer as part of a combination of coating layers that also includes one or more thermal barrier coating (TBC) layer 140, or one or more aluminide coating layer 150, or one or more other bond coat layers, or a combination thereof. In an exemplary embodiment, as illustrated in FIG. 2, protective system 130 may include a bond coat 110 as an oxidation and hot corrosion resistant under layer for at least one TBC layer 140, wherein the bond coat 110 is disposed on the surface 30 of a substrate 120, such as a superalloy substrate, and the at least one TBC layer 140 is disposed on the bond coat 110 and may be subject to exposure to the hot combustion gas.

In another exemplary embodiment, as illustrated in FIG. 3, protective system 130 may include a bond coat 110 as an oxidation and hot corrosion resistant under layer for at least one aluminide layer 150, wherein the bond coat 110 is disposed on the surface 30 of a substrate 120, such as a superalloy substrate, and the at least one aluminide layer 150 is disposed on the bond coat 110 and may be subject to exposure to the hot combustion gas.

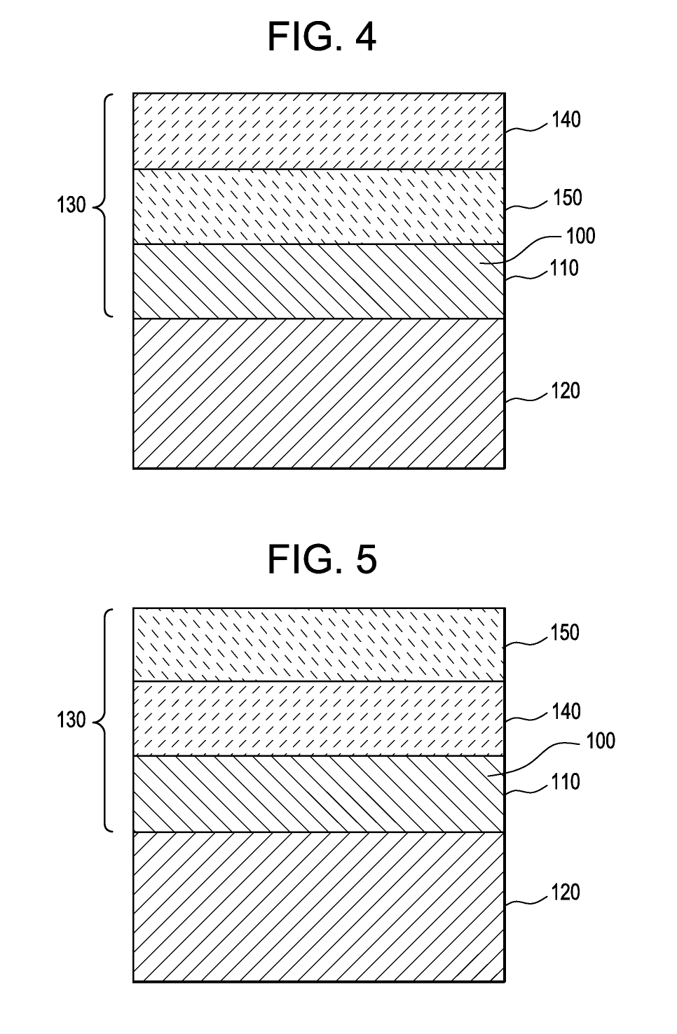

In yet another exemplary embodiment, as illustrated in FIG. 4, protective system 130 may include a bond coat 110 as an oxidation and hot corrosion resistant under layer for an aluminide layer 150 and a TBC layer 140, wherein the bond coat 110 is disposed on the surface 30 of superalloy substrate 120, the at least one aluminide layer 150 is disposed on the bond coat 110 and the at least one TBC layer 140 is disposed on the aluminide layer 150 and may be subject to exposure to the hot combustion gas.

In a further exemplary embodiment, as illustrated in FIG. 5, protective system 130 may include a bond coat 110 as an oxidation and hot corrosion resistant under layer for a TBC layer 140 and an aluminide layer 150, wherein the bond coat 110 is disposed on the surface 30 of superalloy substrate 120, the at least one TBC layer 140 is disposed on the bond coat 110 and the at least one aluminide layer 150 is disposed on the TBC layer 140 and may be subject to exposure to the hot combustion gas.

Protective system 130 may also include bond coat 110 as an inner layer as part of a combination of coating layers that also includes one or more thermal barrier coating (TBC) layer 140, or one or more aluminide layer 150, or a combination thereof. For example, in exemplary embodiments, the protective systems 130 of FIGS. 2-5 may optionally include at least one aluminide layer 150 or another bond coat layer 160 disposed on the substrate 120, between the substrate and the bond coat 110. Otherwise, the arrangement of the bond coat 110, aluminide layer 150 and TBC layer 140 is as described above in FIGS. 2-5.

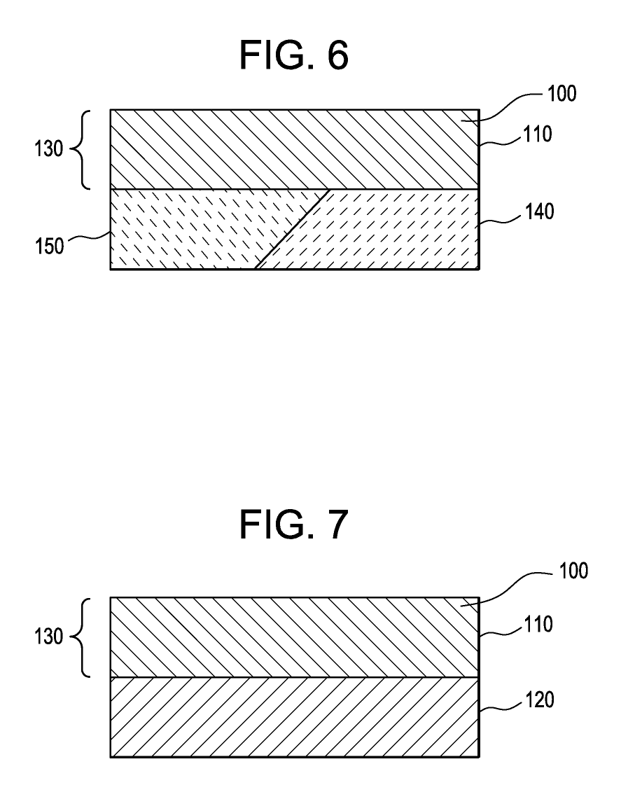

In yet another exemplary embodiment, as illustrated in FIG. 6, protective system 130 may include bond coat 110 as an outer layer as part of a combination of coating layers that also includes one or more thermal barrier coating (TBC) layer 140, or one or more aluminide layer 150, or a combination thereof. Other combinations of one or more bond coat 110 as an outer layer, in combination with one or more TBC layer 140 or one or more aluminide layer 150, or another bond coat layer, or a combination thereof, are also possible.

In a further exemplary embodiment, as illustrated in FIG. 7, protective system 130 may include just bond coat 110 as an outer layer, not in combination with other coating layers. The protective system 130 described above, including those that include bond coat 110 alone, include at least one bond coat 110 layer. The bond coat 110 comprises a nickel-based superalloy bond coat material, and more particularly a nickel-cobalt-based superalloy bond coat material. The nickel-cobalt-based superalloy bond coat material comprises an MCrAlX alloy 100 wherein, by weight of the alloy, M comprises nickel in an amount of at least about 30.0 percent and X comprises from about 0.005 percent to about 0.19 percent yttrium. The MCrAlX alloys 100 disclosed generally employ reduced amounts of yttrium compared to existing MCrAlY bond coat alloys used for turbine engine applications, such as, for example, a conventional gamma-beta MCrAlY (NiCrAlY) bond coat having a nominal composition, by weight of the alloy, 22 percent chromium, 10 percent aluminum, 1 percent yttrium, and the balance nickel and incidental impurities, where sulfur may be an incidental impurity, and is controlled to 100 parts per million (ppm) or less, or a conventional gamma-gamma prime MCrAlY (NiCoCrAlY) bond coat known as BC52 having a nominal composition of 18 percent chromium, 6.5 percent aluminum, 10 percent cobalt, 6 percent tantalum, 2 percent rhenium, 0.5 percent hafnium, 0.3 percent yttrium, 1.0 percent silicon, 0.015 percent zirconium, 0.06 percent carbon, 0.015 boron, and the balance nickel and incidental impurities. The reduced amounts of yttrium in the MCrAlX alloys 100 disclosed herein advantageously provide improved oxidation resistance and increased TBC spallation resistance for these alloys when used in protective systems 130 that also include a TBC layer 140. As compared to the gamma-gamma prime BC52 bond coat material, the MCrAlX alloys 100 disclosed herein are silicon-free to prevent the possibility of formation of brittle TiₓSi_{y} phases when used with alloys that include Ti and improve strain tolerance, have increased amounts of Al to improve oxidation resistance, and are rhenium-free to provide enhanced strain tolerance with regard to the onset of crack initiation (FIG. 10) and avoid the use of this strategically important element, which is strategic owing to its limited supply and associated cost. The MCrAlX alloys 100 disclosed herein also may employ germanium, which is not present in existing MCrAlY bond coat alloys, such those described above.

In an exemplary embodiment, the MCrAlX alloy 100 comprises a nickel-based MCrAlX alloy having a microstructure that includes gamma and gamma prime phases wherein, by weight of the alloy, M comprises nickel in an amount of at least about 30 percent and X comprises from about 0.005 percent to about 0.19 percent yttrium. In another exemplary embodiment, the MCrAlX alloy 100 comprises a nickel-cobalt-based MCrAlX (NiCoCrAlX) alloy 100 having a microstructure that includes gamma and gamma prime phases wherein, by weight of the alloy, M comprises nickel in an amount of at least about 30 percent and cobalt in an amount of about 5.0 percent to about 15.0 percent, and X comprises yttrium in an amount from about 0.005 percent to about 0.19 percent. The MCrAlX alloy 100 may also include germanium in an amount, by weight of the alloy, up to about 1.25 percent.

In one exemplary embodiment, the MCrAlX alloy 100 comprises, by weight of the alloy, from about 5.0 to about 15.0 percent cobalt, from about 12.0 to about 28.0 percent chromium, from about 6.5 to about 11.0 percent aluminum, up to about 1.25 percent germanium, from about 4.0 to about 8.0 percent tantalum, from about 0.005 to about 0.05 percent zirconium, from about 0.005 to about 0.8 percent hafnium, from about 0.005 to about 0.19 percent yttrium, and the balance nickel and incidental impurities. In another embodiment, the MCrAlX alloy 100 comprises, by weight of the alloy, from about 8.5 percent to about 12.0 percent cobalt, from about 16.0 percent to about 21.0 percent chromium, from about 6.5 percent to about 8.5 percent aluminum, from about 4.5 percent to about 7 percent tantalum, from about 0.001 percent to about 0.1 percent zirconium, from about 0.1 percent to about 0.65 percent hafnium, from about 0.005 percent to about 0.19 percent yttrium, up to about 1.25 percent germanium, and the balance nickel and incidental impurities. These MCrAlX alloys 100 have more aluminum than the existing gamma-gamma prime bond coat alloy described herein. Without being limited by theory, this may provide additional aluminum that may avoid depletion of aluminum in the bond coat 110 material during high temperature exposure in an oxidizing environment, and thus promote improved oxidation, hot corrosion and spallation resistance. The addition of The MCrAlX alloys 100 described herein are substantially silicon-free and substantially rhenium-free (i.e., contain substantially no silicon or rhenium other than as an incidental impurity). As used herein, substantially silicon-free means that even where silicon may be present, such as by incorporation as an incidental impurity, it will comprise, by weight of the alloy, about 0.1 percent or less. The absence of silicon avoids the possibility of the formation of brittle TiₓSi_{y} intermetallic phases in or adjacent to the bond coat/substrate interface, particularly where the materials proximate the MCrAlX alloy 100 include titanium. As used herein, substantially rhenium-free means that even where Re may be present, such as by incorporation as an incidental impurity, it will comprise, by weight of the alloy, about 0.1 percent or less. Avoidance of the use of rhenium improves the strain tolerance (FIG. 10) and avoids the need for this strategic element. The incorporation of yttrium and/or germanium in the amounts indicated increases the resistance of the MCrAlX alloy 100 to oxidation and hot corrosion compared to, for example, existing bond coat alloys as described herein that include yttrium in a nominal amount of about 1 percent, and which do not include germanium.

This is illustrated in FIGS. 8-10, for example, which illustrate that the MCrAlX alloys 100 described herein increase the spallation resistance of a protective system that includes a bond coat 110 of the alloy applied to a superalloy substrate 120 as an under layer for a TBC layer 140 as compared to an identical configuration employing an existing gamma-beta bond coat as described herein. Thus, for a given operating temperature, the spallation resistance of a protection system 130 comprising the MCrAlX alloys 100 disclosed herein as a bond coat 110 material under a TBC layer 140 was greater than the resistance of a protection system comprising a bond coat alloy having the composition of the gamma-beta comparative alloy described herein. TBC-coated superalloy coupons of each test group underwent furnace cycle testing (FCT) to assess the relative TBC spallation performance between 1) specimens with an gamma-gamma prime MCrAlX alloy 100 coating system as disclosed herein (Group 1,2) the gamma-gamma prime MCrAlX alloy 100 coating system as disclosed herein with about 2 percent by weight of the alloy of rhenium and about 1 percent by weight of silicon in order to test the effects of rhenium and silicon (Group 2), and comparative specimens with a conventional gamma-beta bond coat as described herein (Group 3). The tests were conducted with twenty four-hour cycles between room temperature and about 2000° F., and with one-hour cycles between a low temperature (about 250° F.) and about 2000° F. The first dwell time was about 20 hours at the peak temperature (FIG. 8), the second dwell time was about 45 minutes at the peak temperature (FIG. 9). Testing of a given specimen was terminated when at least 10% of the TBC has spalled. For the 20 hour dwell test, the results are shown in FIG. 8, where the average FCT life for the Group 1 specimens was about 1740 hours at peak temperature, the Group 2 specimens was about 780 hours and the Group 3 specimens was about 740 hours. In this test, the MCrAlX alloy 100 coating system as disclosed herein demonstrated an improvement over the conventional gamma-beta bond coat of about 2.35 times, and the specimens with rhenium and silicon exhibited behavior comparable to the comparative alloy specimens. For the 45 minute dwell test, the results are shown in FIG. 9, where the average FCT life for the Group 1 specimens was about 810 hours at peak temperature, the Group 2 specimens was about 367 hours and the Group 3 specimens was about 397.5 hours. In this test, the MCrAlX alloy 100 coating system as disclosed herein demonstrated an improvement over the conventional gamma-beta bond coat of about 2.04 times, and the specimens (Group 2) with rhenium and silicon exhibited behavior comparable to the comparative alloy specimens. These specimens were also tested by room temperature uniaxial tensile testing at a constant strain rate to assess their strain tolerance before crack initiation as shown in FIG. 10. The results indicate that the Group 1 specimens had an average strain at crack initiation of about 0.45 percent, comparable to that of the Group 2 specimens, which are illustrated in FIG. 10, and had average strain at crack initiation of about 0.54 percent. The Group 2 specimens had significantly higher average strain at crack initiation of about 3.3 percent.

The above tests demonstrated the ability of the protective system 130 employing MCrAlX alloy 100 bond coating to prevent or at least significantly delay the onset of crack initiation. From another perspective, the use of the MCrAlX alloys 100 disclosed herein also enabled the protection system 130 described, i.e., bond coat 110/TBC coating layer 140, to achieve about the same spallation resistance at an average operating temperature that was at least about 50° F. higher than that of a protective system comprising the existing bond coat alloys described herein and TBC layer 140. Therefore, the MCrAlX alloys 100 described herein improve the spallation resistance sufficiently to enable longer operating lifetimes at the same operating temperature or the similar operating lifetimes at reduced cooling rates, therefore at improved efficiency. For example, for a given spallation life of a protective system 130 employing a TBC layer 140, the protective systems 130 disclosed herein employing bond coat 110 materials may be used at bond coat/TBC interface temperatures that are at least about 50° F. higher than a similar protective system employing the comparative gamma-beta bond coat alloy disclosed herein, for example, which provides higher operating temperature capabilities and improved operating efficiencies and/or longer inspection intervals of the turbine engines employing them. Without being limited by theory, yttrium in the amounts prescribed herein improves oxidation resistance by delaying alumina spallation. Lower Y concentrations in the MCrAlX alloy reduce segregation of Y-rich phases in the coating that can lead to failure. The use of aluminum in the amounts described may also provide additional aluminum that may avoid depletion of aluminum in the bond coat 110 material during high temperature exposure in an oxidizing environment, and thus may also promote improved oxidation, hot corrosion and spallation resistance.

In another exemplary embodiment, the MCrAlX alloys 100 disclosed herein may also include, by weight of the alloy, germanium in an amount up to about 1.25 percent, and more particularly about 0.001 percent to about 1.25 percent.

The incidental impurities may include those incidental to the processing of the individual alloy constituents described herein, particularly those known to be incidental to nickel-based alloys comprising these constituents, and more particularly, to nickel-cobalt-based superalloys comprising these constituents. An example of an incidental impurity is sulfur. The amount of sulfur will preferably be controlled to 8-100 ppm sulfur by weight.

The bond coat 110 material may have a composition different from that of the substrate 120, or may have the same composition. The bond coat 110 may have any suitable thickness. In an exemplary embodiment, the bond coat 110 material may have a thickness of 0.003 inch to about 0.03 inch. In other embodiments, the thicknesses may be greater. The MCrAlX alloys 100 disclosed herein may be used in any suitable form, including as alloy used to form an entire article of the types disclosed herein, or as a bond coat 110 material. The MCrAlX 100 alloys may be formed by any suitable method, including various vacuum melting methods, and particularly melting methods employed for various superalloys, particularly nickel-cobalt-based superalloys. The bond coat 110 material may be applied by any thermal spray process including but not limited to high velocity oxygen fuel spraying (HVOF), high velocity air fuel thermal spray (HVAF), vacuum plasma spray (VPS), air plasma spray (APS), and cold spray methods. Further, the bond coat 110 material can be deposited by various physical vapor deposition (PVD) processes, including cathodic arc physical vapor deposition, electron beam-physical vapor deposition (EBPVD), and ion plasma deposition (IPD).

The protective system 130 may also include an aluminide layer 150 disposed relative to the bond coat 110 material and other coatings as described herein. The aluminide layer 150 may include any suitable aluminide, including a diffusion aluminide such as a simple diffusion aluminide or a complex diffusion aluminide, such as a platinum aluminide. The aluminide layer 150 may have any suitable thickness, and in an exemplary embodiment, may have a thickness from about 0.0005 inch to about 0.0045 inch thick.

The protective system 130 may also include a TBC layer 140 disposed relative to the bond coat 110 material and other coatings as described herein. Any suitable TBC layer 140 may be used, including a dense vertically microcracked (DVM) ceramic TBC layer 140, a porous TBC layer 140 or a hybrid structure. The TBC layer 140 may have any suitable thickness, and in an exemplary embodiment, may have a thickness from about 0.005 inch to about 0.1 inch. An example of a suitable TBC layer 140 includes a TBC which is chemically bonded, for example to the bond coat 110 or aluminide layer 150, as described herein, a strain-tolerant columnar grain structure as may be achieved by depositing the TBC layer 140 using physical vapor deposition techniques as are known in the art (e.g., EBPVD), or by using a plasma spray technique to deposit a non-columnar TBC layer 140. Suitable materials for TBC layer 140 include yttria-stabilized zirconia (YSZ), a preferred composition being about 6 to about 8 weight percent yttria, optionally with up to about 20 weight percent of an oxide of a lanthanide-series element to reduce thermal conductivity. Other ceramic materials may also be used, such as yttria, nonstabilized zirconia, or zirconia stabilized by magnesia, gadolinia, ytterbia, calcia, ceria, scandia, and/or other oxides.

The terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Furthermore, unless otherwise limited all ranges disclosed herein are inclusive and combinable (e.g., ranges of “up to about 25 weight percent (wt. %), more particularly about 5 wt. % to about 20 wt. % and even more particularly about 10 wt. % to about 15 wt. %” are inclusive of the endpoints and all intermediate values of the ranges, e.g., “about 5 wt. % to about 25 wt. %, about 5 wt. % to about 15 wt. %”, etc.). The use of “about” in conjunction with a listing of constituents of an alloy composition is applied to all of the listed constituents, and in conjunction with a range to both endpoints of the range. Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments.

It is to be understood that the use of “comprising” in conjunction with the alloy compositions described herein specifically discloses and includes the embodiments wherein the alloy compositions “consist essentially of” the named components (i.e., contain the named components and no other components that significantly adversely affect the basic and novel features disclosed), and embodiments wherein the alloy compositions “consist of” the named components (i.e., contain only the named components except for contaminants which are naturally and inevitably present in each of the named components).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A high temperature oxidation and hot corrosion resistant MCrAlX alloy, wherein, by weight of the alloy, M comprises nickel in an amount of at least about 30 percent and X comprises from about 0.005 percent to about 0.19 percent yttrium.

2. The alloy of claim 1, wherein X further comprises up to about 1.25 percent germanium by weight of the alloy.

3. The alloy of claim 1, wherein the alloy comprises, by weight of the alloy, from about 5.0 percent to about 15.0 percent cobalt, from about 12.0 percent to about 28.0 percent chromium, from about 6.5 percent to about 11.0 percent aluminum, from about 4.0 percent to about 8.0 percent tantalum, from about 0.005 percent to about 0.5 percent zirconium, from about 0.005 percent to about 0.8 percent hafnium, from about 0.005 percent to about 0.19 percent yttrium, up to about 1.25 percent germanium, and the balance nickel and incidental impurities.

4. The alloy of claim 1, wherein the alloy comprises, by weight of the alloy, from about 8.5 percent to about 12.0 percent cobalt, from about 16.0 percent to about 21.0 percent chromium, from about 6.5 percent to about 8.5 percent aluminum, from about 4.5 percent to about 7 percent tantalum, from about 0.001 percent to about 0.1 percent zirconium, from about 0.1 percent to about 0.65 percent hafnium, from about 0.005 percent to about 0.19 percent yttrium, up to about 1.25 percent germanium, and the balance nickel and incidental impurities.

5. The alloy of claim 1, wherein the alloy comprises substantially no silicon or rhenium.

6. The alloy of claim 3, wherein the incidental impurities comprise sulfur, and sulfur comprises less than about 100 ppm of the alloy.

7. The alloy of claim 1, wherein the alloy comprises a nickel-based alloy comprising gamma and gamma prime phases.

8. A coated article, comprising:
a substrate having a surface; and
a bond coat disposed on the surface, the bond coat comprising a high temperature oxidation and hot corrosion resistant MCrAlX alloy, wherein, by weight of the alloy, M comprises at least about 30 percent nickel and X comprises about 0.005 percent to about 0.19 percent yttrium.

9. The coated article of claim 8, wherein the alloy comprises, by weight of the alloy, from about 5.0 percent to about 15.0 percent cobalt, from about 12.0 percent to about 28.0 percent chromium, from about 6.5 percent to about 11.0 percent aluminum, from about 4.0 percent to about 8.0 percent tantalum, from about 0.005 percent to about 0.5 percent zirconium, from about 0.05 percent to about 0.8 percent hafnium, from about 0.005 percent to about 0.19 percent yttrium, up to about 1.25 percent germanium, and the balance nickel and incidental impurities.

10. The coated article of claim 8, wherein the alloy comprises, by weight of the alloy, from about 8.5 percent to about 12.0 percent cobalt, from about 16.0 percent to about 21.0 percent chromium, from about 6.5 percent to about 8.5 percent aluminum, from about 4.5 percent to about 7 percent tantalum, from about 0.001 percent to about 0.1 percent zirconium, from about 0.1 percent to about 0.65 percent hafnium, from about 0.005 percent to about 0.19 percent yttrium, up to about 1.25 percent germanium, and the balance nickel and incidental impurities.

11. The coated article of claim 8, wherein the alloy comprises substantially no silicon or rhenium.

12. The coated article of claim 10, wherein the incidental impurities comprise sulfur, and sulfur comprises less than about 100 ppm of the alloy.

13. The coated article of claim 8, further comprising a thermal barrier coating disposed on the bond coat.

14. The coated article of claim 8, further comprising an aluminide coating disposed on a surface of the bond coat away from the substrate or disposed between the substrate and the bond coat, or both.

15. The coated article of claim 14, wherein the aluminide coating is disposed on the surface of the bond coat away from the substrate, and further comprising a thermal barrier coating disposed on the aluminide coating.

16. The coated article of claim 8, wherein the substrate comprises an Fe-based, Ni-based or Co-based superalloy, or a combination thereof.

17. The coated article of claim 8, wherein the substrate comprises a turbine blade, vane, shroud, nozzle, combustor or fuel nozzle, or a combination thereof.

18. The coated article of claim 8, wherein the bond coat comprises a replacement bond coat or a repair bond coat, or a combination thereof.

19. The coated article of claim 17, wherein the bond coat comprises a replacement bond coat or a repair bond coat, or a combination thereof.

20. The coated article of claim 8, wherein X further comprises about 0.001 to about 1.25 percent germanium by weight of the alloy.
